(19) United States
(12) Patent Application Publication
(10) Pub. No.: US 2012/0097078 A1
(43) Pub. Date: Apr. 26, 2012

(54) REMOVABLE TABLE TOP DISPLAY

(75) Inventors: Eric SCHWABE, Moose Jaw (CA); Joel PINEL, Moose Jaw (CA)

(73) Assignees: Joel PINEL, Moose Jaw (CA); Eric SCHWABE, Moose Jaw (CA); Hailey SCHWABE, Moose Jaw (CA)

(21) Appl. No.: 12/909,432

(22) Filed: Oct. 21, 2010

(51) Int. Cl. A47B 97/00; A47B 13/08; B32B 38/10

(52) U.S. Cl. 108/90; 156/267

(57) ABSTRACT

The present invention provides for a flexible laminate table top display for releasable attachment to a table top. The flexible laminate table top display has a base substrate having an upper and lower surface, an adhesive layer on the lower surface of the base substrate, at least one printed graphic element on the upper surface of the base substrate and a protective substrate attached to the top surface of the base substrate overlying the top of the printed graphic element.

### FIELD OF THE INVENTION

The present invention relates to a removable, non-damaging, table top display for securing images to the tops of tables. In particular, the present invention relates to a removable, non-damaging table top display that contains a generally clear, wide border which allows for an image to blend with the table with no elevation changes or visible edge. This creates a more esthetically pleasing appearance.

### BACKGROUND OF THE INVENTION

Restaurants, bars and other public establishments provide a unique and effective environment for advertisements. For example, after ordering a meal in a restaurant, there is typically a 10-30 minute wait where diners actively seek out advertising materials. As a result, table top displays are an effective and known advertising medium that provide continuous marketing through daily exposure at venues such as restaurants, lounges or cafeterias. This method of advertising is seen by a high volume of potential customers and is not exclusive to those sitting at the table, but is also seen by those passing by.

Prior arrangements of table top displays are disclosed in U.S. Pat. No. 5,484,638 and U.S. Pat. No. 5,861,075. Both patents teach table top displays that are capable of displaying an image or advertisement which is resistant to damages, particularly chipping, water damage or heat damage. An epoxy or similar top coating is applied on top of the advertisement or imaging rendering it permanently adhered to the table. This is not suitable to all owners of public establishments or advertisers as it does not allow them to change or remove their advertisement from the table. With these table top displays, owners of the public establishments would have to purchase new tables if the advertiser wishes to discontinue their campaign or are limited to only long term advertising agreements. This prior art is not suitable for short term advertising.

There is a need for a removable table top adverting system allows more flexibility to both owners of public establishments and advertisers as it allows for the removal or change of an advertisement without any damage to the table. This is also convenient as it is easy to install and allows for month-to-month or event based advertising.

The invention is made in view of such a problem and it's object is to provide a non-damaging, removable laminate substrate. More specifically, the object is to provide a non-damaging, removable laminate substrate for use in table top advertising.

### SUMMARY OF THE INVENTION

The present invention provides for a flexible laminate table top display for releasable attachment to a table top. The flexible laminate table top display comprises a base substrate having an upper and lower surface, an adhesive layer on the lower surface of the base substrate, at least one printed graphic element on the upper surface of the base substrate and a protective substrate attached to the top surface of the base substrate overlying the top of the printed graphic element.

In an aspect of the invention, the base substrate and the protective substrate are both generally transparent.

In another aspect of the invention, the flexible laminate table top display can be removed from a table top upper surface without damage, preferably by the use of heat.

In a further aspect of the invention, the printed graphic element is an advertisement.

In yet another aspect of the invention, the base substrate is made of vinyl or polyester.

In a further aspect of the invention the protective substrate is made of vinyl or PET polyester.

In another aspect of the invention there is provided a method of manufacture of a laminate substrate for use in a table top display comprising a base substrate having an upper and lower surface, wherein a white image is spot printed on said upper surface of said base substrate, a secondary graphic element is spot printed directly on top of said base white graphic, a flexible protective substrate is affixed on top of said graphic element on said upper surface of said base substrate, and the complete laminate substrate is trimmed to a desired size.

In another aspect of the invention, the protective substrate is affixed to the upper surface of the base substrate by cold lamination.

In another aspect of the invention, there is provided a method of installation of a table top display on the flat upper surface of a table wherein said table top display is a laminate substrate comprising a base substrate having an upper and lower surface, an adhesive layer on the lower surface of said base substrate, at least one printed graphic element on the upper surface of said base substrate and a protective substrate adhered to the top of said printed graphic element on said top surface of said base substrate; wherein said flat upper surface of the table is misted with a solution; said laminate substrate is placed on top of said flat upper surface; said laminate substrate is adjusted relative to said upper flat surface of said table to a desired position; pressure is applied to said upper surface of said laminate substrate to remove said solution from between said lower surface of said laminate substrate and said flat upper surface of said table exposing said adhesive to said flat upper surface of said table allowing for fixation of said lower surface of said laminate substrate to said flat upper surface of said table; said laminate substrate is trimmed to size of said flat upper surface of said table.

In an aspect of the invention in the method of installation of a table top display as described above, the laminate substrate is adjusted relative to the flat upper surface of the table such that the printed graphic element is generally centered on the flat upper surface of the table.

### BRIEF DESCRIPTION OF THE DRAWINGS

Preferred embodiments of the present invention are illustrated in the attached drawings in which:

FIG. 1 is a perspective view of the preferred embodiment of the table top display;

FIG. 2 is a perspective cut away view of the table top display of FIG. 1 detailing the layers of the laminate substrate; and

FIG. 3 is a side section view of the table top display of FIG. 1.

### DETAILED DESCRIPTION OF THE PREFERRED EMBODIMENT

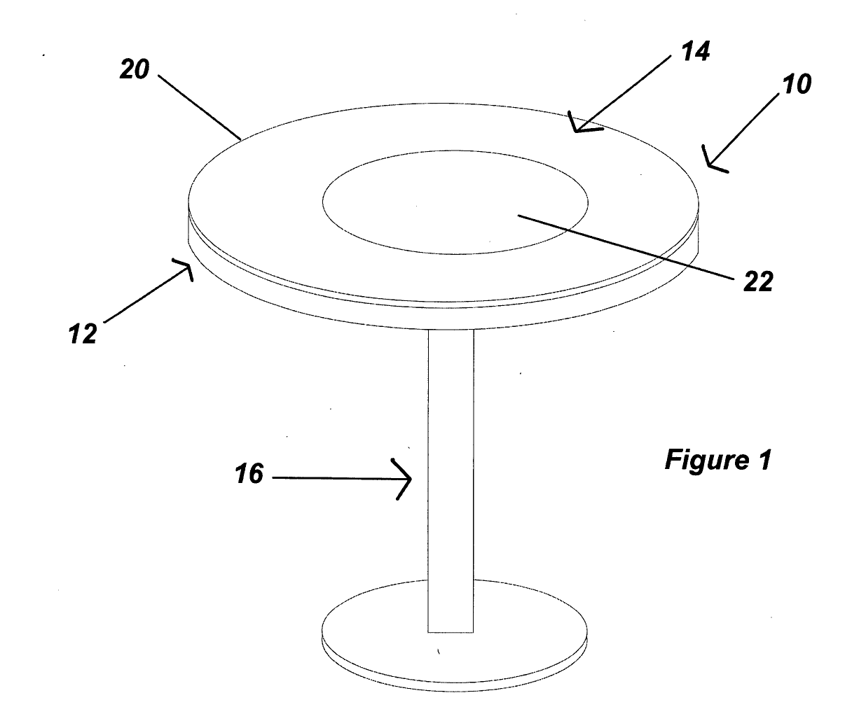

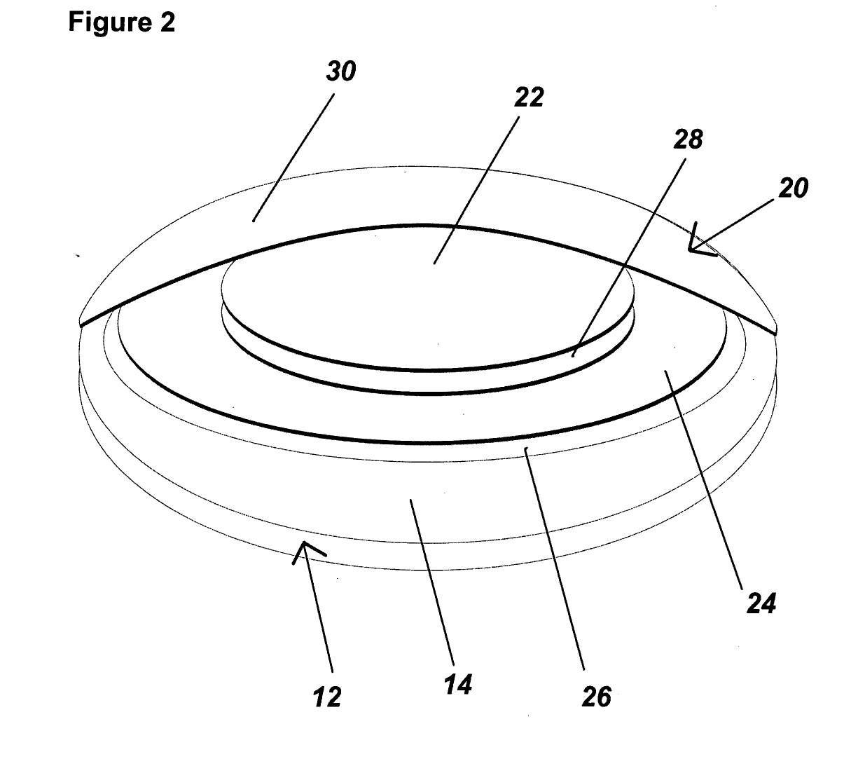

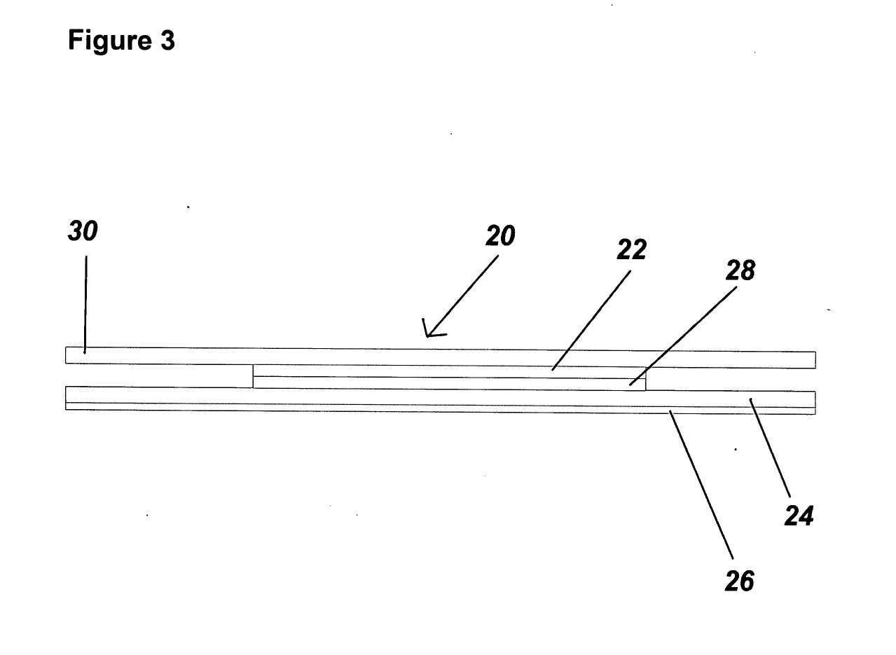

The present invention pertains to a table top display. FIG. 1 depicts a table 10 having a table top 12, including a flat upper surface 14, vertical support members 16 and a removable laminate substrate 20. The table top 12 includes a generally flat upper surface 14 and could be made of a wide variety of substances including, metal, wood, fiberglass, composites or other materials. The removable laminate substrate 20 comprises several layers as shown in FIGS. 2 and 3 and includes a graphic element 22. The graphic element 22 is preferably an advertisement, but could be decorative in nature. The graphic element 22 may also include information directing the viewer to sources of additional information such as a web site address or may include 2D or 3D barcodes such as AZTEC CODE or MICROSOFT TAG readable by smart phones to display additional information to the viewer.

Referring to FIGS. 2 and 3, the removable laminate substrate 20 has a flexible base substrate 24, backed with adhesive 26 that can be fixed to the upper flat surface 14 of table top 12. It is preferably made of transparent vinyl or PET polyester with a thickness of 2 to 5 mil, preferably vinyl with a thickness of 4 mil and is capable of accepting the printing of a graphic element 22 onto its top surface. Typically this entails that the flexible base substrate 24 be compatible with a printer. In order for this graphic element 22 to have suitable colour and quality, it is preferable that the graphic element 22 be opaque. One means to accomplish this is to spot print a white base 28 to a portion of the base substrate 24 relating to the size and location of the desired final graphic element 22. The white ink is allowed to dry before the desired graphic element 22 is printed on top of the white portion of the base substrate 24. This allows for images of photograph quality to be fixed to a table top.

A flexible protective substrate 30 is applied to the top surface of the base substrate 24 and fixed thereon. Although alternative methods of fixation are possible, the preferred method of fixation is cold lamination. The flexible protective substrate 30 ensures that the graphic element 22 and table top 12 is not affected by spills, heat, scratches and other forms of damage. This layer is made of 2 to 5 mil, more preferably thick vinyl or PET polyester, 4 mil thick PET polyester, however other materials can also be used.

Once the graphic element 22 has been applied to the base substrate 24 and the protective substrate 30 has been fixed thereon, the removable laminate substrate 20 is complete. It is cut to a size approximately half an inch larger than the table. To install the removable laminate substrate 20, the upper flat surface 14 of the table top 12 is misted with a water and soap solution. The soap solution allows for some movement of the removable laminate substrate 20 relative to the table top 12, which allows for fine adjustments before the removable laminate substrate 20 is fixed to the table top 12. Once the graphic element 22 is in the desired location on the table top 12 pressure is applied to the removable laminate substrate 30 using a roller or squeegee. This pushes most of the moisture out from under the laminate substrate 30 as it smoothes the removable laminate substrate 30, creating a blemish free finish void of any bubbles or wrinkles. This process also exposes the adhesive 26 on the bottom surface of the base substrate 24 to the table, fixing the two for any desired length of time. At this point the excess removable laminate substrate 20 is trimmed with a blade to correspond with the dimension of the upper flat surface 14 of the table top 12. The removable laminate substrate 20 can be removed safely without any damage to the table top 12 by heating the removable laminate substrate 20 to loosen the adhesive.

The preferred embodiment of this invention includes the displaying of a graphic element 22 that is located centrally on the table top 14 and includes a generally clear, wide border. Preferably, the wide, clean border is about 3 inches to provide the centering of the graphic element 22. Although it can be appreciated that there could be many variations, it is preferred that for smaller table tops of 36 inches in width and less, the printed graphic element covers less than 75% of the surface of the table, leaving a wide border around the graphic element 22 which accounts for at least 25% of the table surface. The printing process described above enables the graphic element 22 to blend with the table top 12 with no elevation changes or visible edge. This creates a more visually appealing table top. The particular embodiment described provides a vibrantly coloured, smooth, blemish free, tamper resistant and non-obtrusive graphic finish to any table top.

Although various preferred embodiments of the present invention have been described herein in detail, it will be appreciated by those skilled in the art that variations may be made thereto without departing from the spirit of the invention or scope of the appended claims.

1. A flexible laminate table top display for releasable attachment to a table top, the flexible laminate table top display comprising a base substrate having an upper and lower surface, an adhesive layer on the lower surface of said base substrate, at least one printed graphic element on the upper surface of said base substrate and a protective substrate attached to said top surface of said base substrate overlying the top of said printed graphic element.

2. A flexible laminate table top display as claimed in claim 1 wherein said base substrate and said protective substrate are both generally transparent.

3. A flexible laminate table top display as claimed in claim 1 wherein said flexible laminate substrate can be removed from a table top upper surface without damage.

4. A flexible laminate table top display as claimed in claim 2 wherein said adhesive is heat releasable to facilitate removal of said flexible laminate substrate.

5. A flexible laminate table top display as claimed in claim 3 wherein said printed graphic element is an advertisement.

6. A flexible laminate table top display as claimed in claim 1 wherein said base substrate is made of vinyl or PET polyester.

7. A table top display as claimed in claim 1 wherein said protective substrate is made of vinyl or PET polyester.

8. A flexible laminate table top display as claimed in claim 1 wherein said base substrate is made of vinyl and said protective substrate is made of PET polyester.

9. A flexible laminate table top display as claimed in claim 5 wherein a wide border surrounds the graphic element.

10. A flexible laminate table top display as claimed in claim 9 wherein said wide border is about 3 inches wide.

11. A method of manufacture of a laminate substrate for use in a table top display comprising a base substrate having an upper and lower surface, wherein a white image is spot printed on said upper surface of said base substrate, a secondary graphic element is spot printed directly on top of said base white graphic, a flexible protective substrate is affixed on top of said graphic element on said upper surface of said base substrate, and the complete laminate substrate is trimmed to a desired size.

12. A method of manufacture of a laminate substrate for use in a table top display as claimed in claim 11 wherein said protective substrate is affixed to said upper surface of said base substrate by cold lamination.

13. A method of installation of a table top display on the flat upper surface of a table wherein said table top display is a laminate substrate comprising a base substrate having an upper and lower surface, an adhesive layer on the lower surface of said base substrate, at least one printed graphic element on the upper surface of said base substrate and a protective substrate adhered to the top of said printed graphic element on said top surface of said base substrate; wherein said flat upper surface of the table is misted with a solution; said laminate substrate is placed on top of said flat upper surface; said laminate substrate is adjusted relative to said upper flat surface of said table to a desired position; pressure is applied to said upper surface of said laminate substrate to remove said solution from between said lower surface of said laminate substrate and said flat upper surface of said table exposing said adhesive to said flat upper surface of said table allowing for fixation of said lower surface of said laminate substrate to said flat upper surface of said table; said laminate substrate is trimmed to size of said flat upper surface of said table.

14. A method of installation of a table top display as claimed in claim 13 wherein said laminate substrate is adjusted relative to said flat upper surface of said table such that said printed graphic element is generally centered on said flat upper surface of said table. 15, A method of installation of a table top display as claimed in claim 13 wherein said pressure is applied using one or both of a squeegee and a roller.
